(19) United States
(12) Patent Application Publication
(10) Pub. No.: US 2026/0180115 A1
(43) Pub. Date: Jun. 25, 2026

(54) ENERGY STORAGE DEVICE

(71) Applicants: TOYOTA JIDOSHA KABUSHIKI KAISHA, Toyota-shi (JP); Prime Planet Energy & Solutions, Inc., Tokyo (JP)

(72) Inventors: Masato ONO, Nagoya-shi (JP); Norihiro OSE, Nagoya-shi (JP); Yasuhiro SAKASHITA, Nisshin-shi (JP); Koichi YANASE, Nagoya-shi (JP); Takeru HARA, Toyota-shi (JP); Yuka YOKOI, Nagoya-shi (JP); Kohji UMEMURA, Okazaki-shi (JP); Toshiki IMABORI, Kasai-shi (JP); Yoshinori HIRANO, Nagoya-shi (JP); Satoshi FUJIMURA, Toki-shi (JP)

(73) Assignees: TOYOTA JIDOSHA KABUSHIKI KAISHA, Toyota-shi (JP); Prime Planet Energy & Solutions, Inc., Tokyo (JP)

(21) Appl. No.: 19/423,501

(22) Filed: Dec. 17, 2025

(30) Foreign Application Priority Data
Dec. 24, 2024 (JP) 2024-227636

(51) Int. Cl. H01M 50/317; H01M 50/103; H01M 50/141; H01M 50/249

(52) U.S. Cl. CPC H01M 50/317; H01M 50/103; H01M 50/141; H01M 50/249

(57) ABSTRACT

An energy storage device includes an electrode assembly and a housing case housing the electrode assembly. The housing case includes a first main wall having a valve hole, and a vent valve closing the valve hole. The vent valve includes a tubular member, a closure film member provided inside the tubular member, and an engaging member and a support member that are connected to the tubular member. The tubular member extends along a hole surface that defines the valve hole. The engaging member is provided on the outer surface of the first main wall. The support member is provided on the inner surface of the first main wall, and supports the electrode assembly.

### CROSS-REFERENCE TO RELATED APPLICATION

This application claims priority to Japanese Patent Application No. 2024-227636 filed on Dec. 24, 2024. The disclosure of the above-identified application, including the specification, drawings, and claims, is incorporated by reference herein in its entirety.

### BACKGROUND

### 1. Technical Field

The present disclosure relates to energy storage devices.

### 2. Description of Related Art

Various types of energy storage cells have been proposed for use in energy storage devices. For example, Japanese Unexamined Patent Application Publication No. 2023-173774 (JP 2023-173774 A) discloses an energy storage cell including a housing case and an electrode assembly housed in the housing case. A vent valve member is formed in a wall of the housing case.

### SUMMARY

In general, in an energy storage cell, which is a secondary cell, an electrode assembly housed in the energy storage cell repeatedly expands and contracts during charging and discharging. As a result, components such as the current collecting tabs of the electrode assembly may be damaged due to, for example, misalignment of the electrode assembly.

The present disclosure has been made in view of the above issue, and an object thereof is to provide an energy storage device in which a vent valve of an energy storage cell mounted therein suppresses misalignment of an electrode assembly of the energy storage cell and thus suppresses damage to the electrode assembly.

An energy storage device according to the present disclosure includes an electrode assembly and a housing case housing the electrode assembly. The housing case includes a first main wall having a valve hole, and a vent valve closing the valve hole. The vent valve includes a tubular member, a closure film member provided inside the tubular member, and an engaging member and a support member that are connected to the tubular member. The tubular member extends along a hole surface that defines the valve hole. The engaging member is provided on an outer surface of the first main wall. The support member is provided on an inner surface of the first main wall, and supports the electrode assembly.

In the energy storage device according to the present disclosure, a water-repellent film having higher water repellency than the closure film member may be provided on an outer surface of the closure film member.

In the energy storage device according to the present disclosure, irregularities may be provided on an inner surface of the closure film member.

In the energy storage device according to the present disclosure, the housing case may include a second main wall spaced apart from the first main wall in a first direction, and a peripheral wall connecting the first main wall and the second main wall. The peripheral wall may include a first side wall and a second side wall that are spaced apart in a second direction intersecting with the first direction. The support member may extend from the first side wall to the second side wall.

In the energy storage device according to the present disclosure, the support member may be in contact with the electrode assembly.

According to the energy storage device of the present disclosure, the vent valve of the energy storage cell mounted in the energy storage device can suppress misalignment of the electrode assembly, thereby suppressing damage to the electrode assembly of the energy storage cell.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a vehicle equipped with an energy storage device according to an embodiment of the present disclosure;

FIG. 2 is an exploded perspective view of the energy storage device according to the embodiment of the present disclosure;

FIG. 3 is a perspective view of an energy storage cell included in the energy storage device according to the embodiment of the present disclosure;

FIG. 4 is an exploded perspective view of the energy storage cell according to the embodiment of the present disclosure;

FIG. 5 is a sectional view of the energy storage cell shown in FIG. 3, taken along line V-V and viewed in the direction of the arrows;

FIG. 6 is a sectional view of a first modification of a closure film member shown in FIG. 5 according to the embodiment of the present disclosure;

FIG. 7 is a perspective view of a second modification of the energy storage cell according to the embodiment of the present disclosure; and

FIG. 8 is a cross-sectional view of the second modification of the energy storage cell shown in FIG. 7, taken along line VIII-VIII and viewed in the direction of the arrows.

### DETAILED DESCRIPTION OF EMBODIMENTS

An embodiment and modifications of the present disclosure will be described in detail below with reference to the drawings. The same or corresponding portions are denoted by the same signs throughout the drawings, and description thereof will not be repeated.

### Embodiments

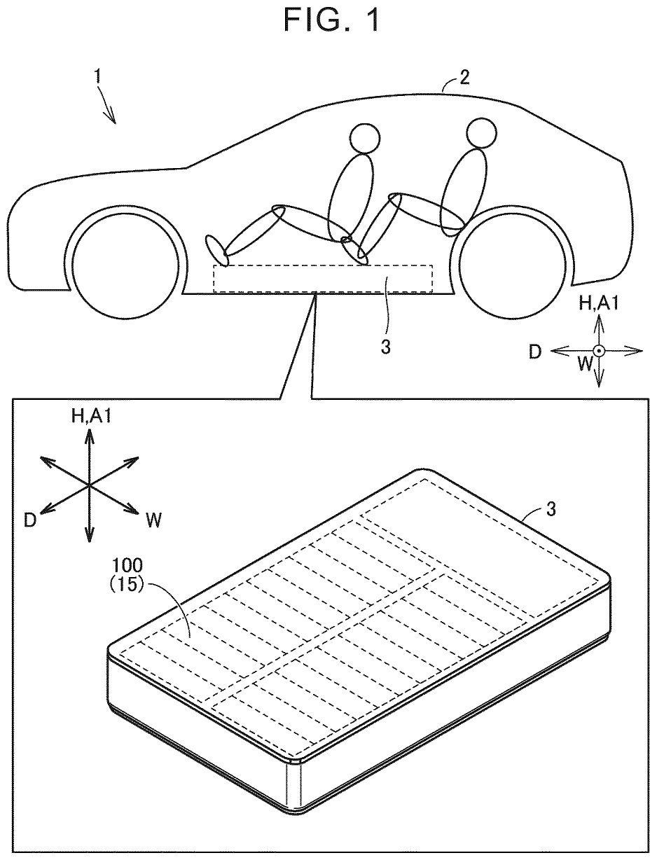

FIG. 1 is a side view schematically illustrating a vehicle equipped with an energy storage device according to an embodiment of the present disclosure. The up-down direction H in FIG. 1 indicates the up-down direction of a vehicle 1. The width direction W indicates the width direction of the vehicle 1. The front-rear direction D indicates the front-rear direction of the vehicle 1. The up-down direction His an example of the “first direction” according to the present disclosure, and the width direction W is an example of the “second direction” according to the present disclosure.

The vehicle 1 includes a vehicle body 2 and an energy storage device 3. Examples of the vehicle 1 include a plug-in hybrid electric vehicle (PHEV), a battery electric vehicle (BEV), and a fuel cell electric vehicle (FCEV). The energy storage device 3 is mounted in a lower portion of the vehicle body 2.

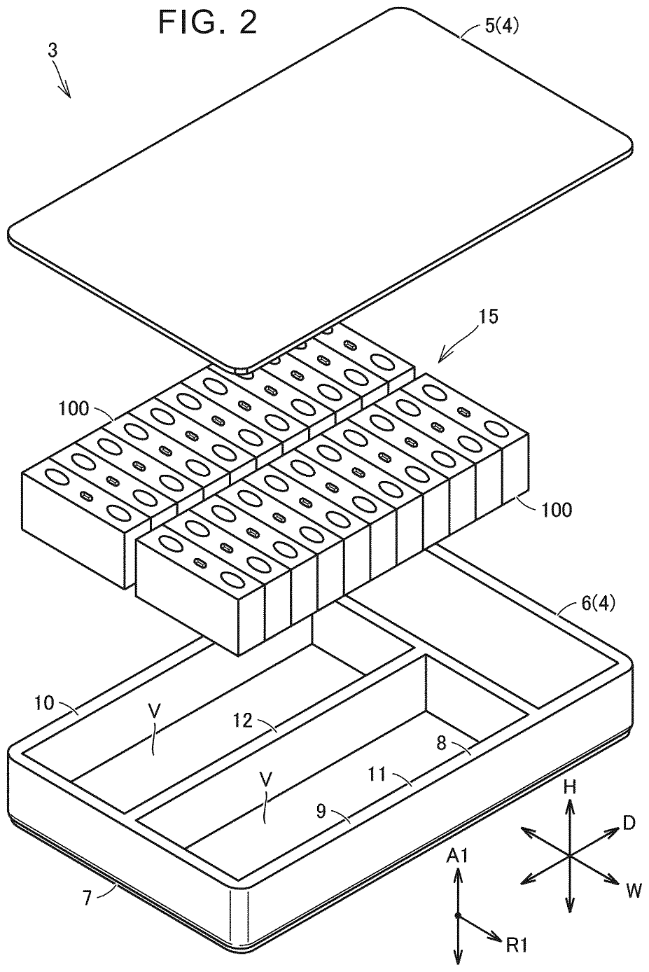

FIG. 2 is an exploded perspective view of the energy storage device according to the embodiment of the present disclosure. The energy storage device 3 includes a housing case 4 and an energy storage stack 15.

The housing case 4 includes an upper cover 5 and a lower case 6. The housing case 4 forms a housing space V that is defined by the upper cover 5 and the lower case 6.

The upper cover 5 covers the lower case 6 that is open at the top.

The lower case 6 includes a bottom wall 7 and a wall 8. The bottom wall 7 supports the energy storage stack 15 in the up-down direction H.

The wall 8 extends upward from the bottom wall 7 in the up-down direction H. The wall 8 includes a peripheral wall 9 and a reinforcing portion 12. The peripheral wall 9 extends in a frame shape and upward in the up-down direction H from the outer peripheral edge of the bottom wall 7. The peripheral wall 9 includes a first wall 10 and a second wall 11, each extending upward in the up-down direction H. The first wall 10 and the second wall 11 extend in the front-rear direction D, and are spaced apart in the width direction W.

The reinforcing portion 12 extends in the front-rear direction D. The reinforcing portion 12 is disposed along the center in the width direction W between the first wall 10 and the second wall 11.

The energy storage stack 15 is housed in the housing space V and is placed on the upper surface of the bottom wall 7. The energy storage stack 15 is made up of a plurality of energy storage cells 100. The energy storage cells 100 are arranged in the front-rear direction D. The energy storage cells 100 have a rectangular parallelepiped shape that is elongated in the width direction W.

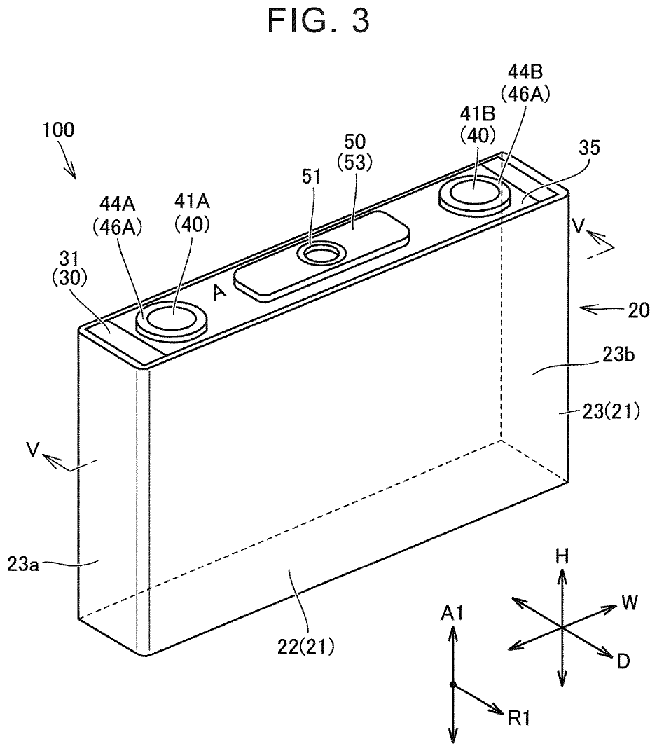

FIG. 3 is a perspective view of the energy storage cell 100. As shown in FIG. 3, the energy storage cell 100 according to the present embodiment is a prismatic cell. The energy storage cell 100 may be a rechargeable secondary cell such as a lithium-ion cell or a nickel metal hydride cell.

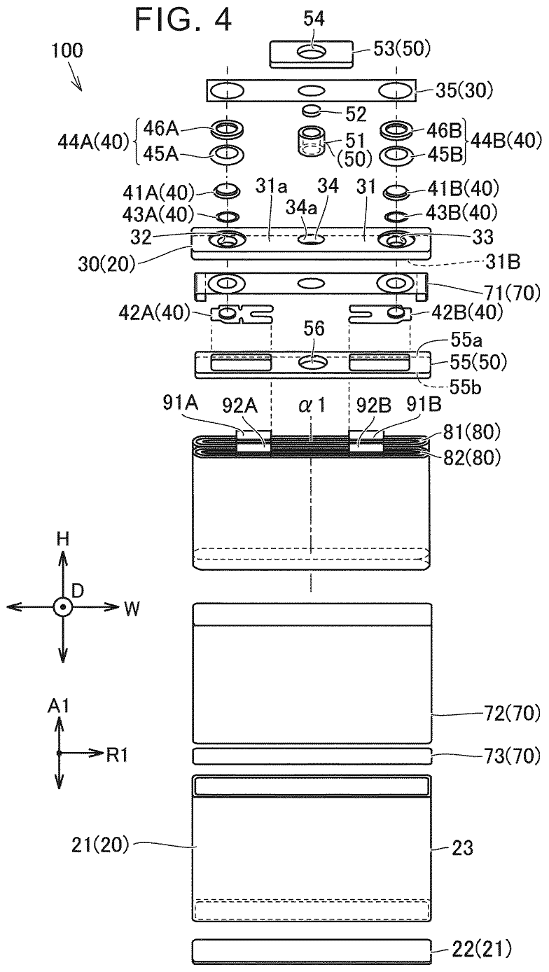

FIG. 4 is an exploded perspective view of the energy storage cell according to the present embodiment. As shown in FIG. 4, the energy storage cell 100 includes a housing case 20, an insulating member 70, and a plurality of electrode assemblies 80.

The housing case 20 is electrically conductive. The housing case 20 is made of a metal such as aluminum. The housing case 20 houses the electrode assemblies 80. The housing case 20 also houses an electrolyte solution (not shown in FIG. 4). The housing case 20 includes a case body 21 and a top plate 30.

The case body 21 includes a bottom plate 22 and a peripheral wall 23 that extends upward in the up-down direction H from the bottom plate 22. The bottom plate 22 is joined to the peripheral wall 23 at the outer peripheral edge of the bottom plate 22. The bottom plate 22 is an example of the “second main wall” of the present disclosure.

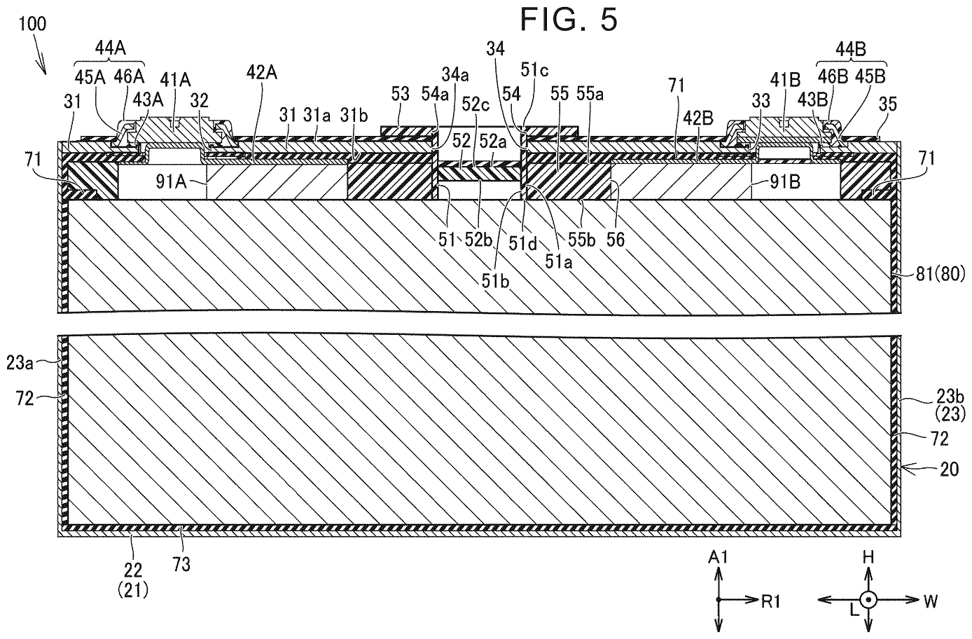

The peripheral wall 23 extends upward in the up-down direction H from the bottom plate 22. The peripheral wall 23 connects the bottom plate 22 and a top plate body 31 that will be described later. The peripheral wall 23 has a substantially rectangular outer shape as viewed in the up-down direction H. The peripheral wall 23 is made of a metal such as aluminum. The peripheral wall 23 includes a first side wall 23a and a second side wall 23b shown in FIG. 5. The first side wall 23a and the second side wall 23b are spaced apart in the width direction W.

Referring back to FIG. 4, the top plate 30 includes a top plate body 31, an insulating cover 35, an electrode terminal 40, and a vent valve 50. The top plate body 31 is an example of the “first main wall” of the present disclosure.

The top plate body 31 is joined to the outer peripheral edge of the peripheral wall 23 by, for example, welding so as to close the opening of the peripheral wall 23. The top plate body 31 is spaced apart from the bottom plate 22 in the up-down direction H. The top plate body 31 has an outer surface 31a and an inner surface 31b. The inner surface 31b and the outer surface 31a are spaced apart in the up-down direction H. The outer surface 31a is located farther from the electrode assemblies 80 than the inner surface 31b. The top plate body 31 has a first connection hole 32, a second connection hole 33, and a valve hole 34. The valve hole 34 is formed in the top plate body 31 between the first connection hole 32 and the second connection hole 33 in the width direction W. The valve hole 34 is defined by a hole surface 34a of the top plate body 31.

The insulating cover 35 covers the outer surface 31a of the top plate body 31.

The electrode terminal 40 is provided in the top plate body 31. The electrode terminal 40 includes a first external terminal 41A, a second external terminal 41B, a first connection member 42A, a second connection member 42B, a first seal ring 43A, a second seal ring 43B, a first terminal support portion 44A, and a second terminal support portion 44B.

The first external terminal 41A and the second external terminal 41B are provided so as to be exposed to the outside of the energy storage cell 100.

The first connection member 42A and the second connection member 42B are electrically conductive. The first connection member 42A and the second connection member 42B are disposed with at least part of each located inside the housing case 20.

The first external terminal 41A or the first connection member 42A is inserted through the first connection hole 32. The first external terminal 41A and the first connection member 42A are joined to each other. The first connection member 42A is electrically connected to the electrode assemblies 80. Accordingly, the first external terminal 41A is electrically connected to the electrode assemblies 80.

The second external terminal 41B or the second connection member 42B is inserted through the second connection hole 33. The second external terminal 41B and the second connection member 42B are joined to each other. The second connection member 42B is electrically connected to the electrode assemblies 80. Accordingly, the second external terminal 41B is electrically connected to the electrode assemblies 80.

The first seal ring 43A is provided along the first connection hole 32. The first seal ring 43A is provided in a gap between the top plate body 31 and the first external terminal 41A to seal the gap. The second seal ring 43B is provided along the second connection hole 33. The second seal ring 43B is provided in a gap between the top plate body 31 and the second external terminal 41B to seal the gap. The first seal ring 43A and the second seal ring 43B are electrically insulating.

The first terminal support portion 44A is retained in the top plate body 31. The first terminal support portion 44A supports the first external terminal 41A from the outer periphery of the first external terminal 41A. The first terminal support portion 44A includes a first retaining ring 45A and a first covering ring 46A. The first retaining ring 45A extends annularly so as to surround the first connection hole 32, and is directly retained by the top plate body 31. The first covering ring 46A covers the first retaining ring 45A. The first retaining ring 45A supports the first external terminal 41A via the first covering ring 46A. The first covering ring 46A is an electrically insulating resin member.

The second terminal support portion 44B is retained in the top plate body 31. The second terminal support portion 44B supports the second external terminal 41B from the outer periphery of the second external terminal 41B. The second terminal support portion 44B includes a second retaining ring 45B and a second covering ring 46B. The second retaining ring 45B extends annularly so as to surround the second connection hole 33, and is directly retained by the top plate body 31. The second covering ring 46B covers the second retaining ring 45B. The second retaining ring 45B supports the second external terminal 41B via the second covering ring 46B. The second covering ring 46B is an electrically insulating resin member.

The vent valve 50 includes a tubular member 51, a closure film member 52, an engaging member 53, and a support member 55. The vent valve 50 closes the valve hole 34. The vent valve 50 will be described in detail later with reference to FIG. 5. In FIG. 4, the tubular member 51, the closure film member 52, the engaging member 53, and the support member 55 of the vent valve 50 are illustrated as separate members. However, the vent valve 50 and the top plate 30 may be formed integrally. Alternatively, among the tubular member 51, the closure film member 52, the engaging member 53, and the support member 55 of the vent valve 50, some may be formed integrally while the others remain separate.

The insulating member 70 is electrically insulating. The insulating member 70 is disposed between the electrode assemblies 80 and the housing case 20. The insulating member 70 electrically insulates the electrode assemblies 80 from the housing case 20. The insulating member 70 includes an insulating bracket 71, a peripheral surface insulating portion 72, and a bottom surface insulating portion 73.

The insulating bracket 71 is disposed between the electrode assemblies 80 and the top plate body 31. The insulating bracket 71 has relatively high rigidity and is in contact with both the electrode assemblies 80 and the top plate body 31. Accordingly, the electrode assemblies 80 are fixed in the housing case 20 in the up-down direction H. The peripheral surface insulating portion 72 is disposed between the electrode assemblies 80 and the peripheral wall 23. The peripheral surface insulating portion 72 is a member in the form of a film. The bottom surface insulating portion 73 is disposed between the electrode assemblies 80 and the bottom plate 22. The bottom surface insulating portion 73 is a member in the form of a film. In the present embodiment, the bottom surface insulating portion 73 is bonded to the electrode assemblies 80.

The electrode assemblies 80 are so-called wound electrode assemblies. The electrode assemblies 80 typically include a first electrode assembly 81 and a second electrode assembly 82. The first electrode assembly 81 and the second electrode assembly 82 are arranged adjacent to each other in the front-rear direction D. The peripheral surface insulating portion 72 may integrally cover the electrode assemblies 80 such that the first electrode assembly 81 and the second electrode assembly 82 are fixed together. The first electrode assembly 81 is formed by winding a group of sheets around a winding axis α1. A first axial direction A1 of the winding axis α1 is a direction passing through the case body 21 and the top plate body 31, that is, the same direction as the up-down direction H. The group of electrode sheets includes, for example, a first separator, a first electrode sheet, a second separator, and a second electrode sheet. As the group of sheets is wound around the winding axis α1, the first separator, the first electrode sheet, the second separator, and the second electrode sheet are stacked in a first radial direction R1 that intersects with, and is centered on, the first axial direction A1. The first electrode sheet includes a first current collector sheet and a first active material layer. Both surfaces of the first current collector sheet are coated with the first active material layer. The second electrode sheet includes a second current collector sheet and a second active material layer. Both surfaces of the second current collector sheet are coated with the second active material layer. For example, the first electrode sheet is a positive electrode and the second electrode sheet is a negative electrode. The first electrode assembly 81 and the second electrode assembly 82 have substantially the same configuration.

The first electrode assembly 81 includes a first tab 91A and a second tab 91B. The second electrode assembly 82 includes a first tab 92A and a second tab 92B. The first tab 91A electrically connects a first electrode (not shown) of the first electrode assembly 81 to the first connection member 42A. The second tab 91B electrically connects a second electrode (not shown) of the first electrode assembly 81 to the second connection member 42B. The first tab 92A electrically connects a second electrode (not shown) of the second electrode assembly 82 to the first connection member 42A. The second tab 92B electrically connects a second electrode (not shown) of the second electrode assembly 82 to the second connection member 42B.

The first tabs 91A, 92A are arranged side by side in the front-rear direction D. The first tabs 91A, 92A are joined to each other by, for example, ultrasonic welding. The first tabs 91A, 92A are joined to the first connection member 42A by, for example, ultrasonic welding. The second tabs 91B, 92B are arranged side by side in the front-rear direction D. The second tabs 91B, 92B are joined to each other by, for example, ultrasonic welding. The second tabs 91B, 92B are joined to the second connection member 42B by, for example, ultrasonic welding.

FIG. 5 is a sectional view of the energy storage cell shown in FIG. 3, taken along line V-V and viewed in the direction of the arrows.

The vent valve 50 includes the tubular member 51, the closure film member 52, the engaging member 53, and the support member 55. The vent valve 50 is made of, for example, an electrically insulating resin material. In FIG. 5, the tubular member 51, the closure film member 52, and the support member 55 may be integrally formed.

The tubular member 51 extends along the hole surface 34a that defines the valve hole 34. The tubular member 51 has an annular shape and extends in the up-down direction H. The tubular member 51 has an outer peripheral surface 51a, an inner peripheral surface 51b, a first end face 51c, and a second end face 51d. The tubular member 51 is connected to the hole surface 34a at the outer peripheral surface 51a. The first end face 51c and the second end face 51d are spaced apart in the up-down direction H. The first end face 51c is located farther from the electrode assemblies 80 than the outer surface 31a of the top plate body 31. That is, the first end face 51c is located at the opposite side of the top plate body 31 from the electrode assemblies 80 in the up-down direction H, and is spaced apart from the outer surface 31a of the top plate body 31 in the up-down direction H. The second end face 51d is located closer to the electrode assemblies 80 than the inner surface 31b. That is, the second end face 51d is located at the side of the top plate body 31 facing the electrode assemblies 80 in the up-down direction H.

The closure film member 52 is formed inside the tubular member 51. The closure film member 52 closes the tubular member 51. More specifically, the closure film member 52 is connected to the inner peripheral surface 51b of the tubular member 51, thereby closing the tubular member 51. The closure film member 52 has an outer surface 52a and an inner surface 52b. The outer surface 52a and the inner surface 52b are spaced apart in the up-down direction H. The outer surface 52a is located farther from the electrode assemblies 80 than the inner surface 52b. The inner surface 52b is located closer to the electrode assemblies 80 than the outer surface 52a. A water-repellent film 52c may be formed on the outer surface 52a of the closure film member 52.

The water-repellent film 52c has higher water repellency than the closure film member 52. The expression that the water-repellent film 52c has higher water repellency than the closure film member 52 means, for example, that the wetting tension of the material forming the water-repellent film 52c is lower than that of the material forming the closure film member 52. The wetting tension (mN/m) is measured according to the test method described in JIS K 6768. That is, the wetting tension (mN/m) is measured by dropping multiple liquids with progressively different surface tensions onto the surface of the target material and observing how each liquid spreads. Alternatively, the expression that the water-repellent film 52c has higher water repellency than the closure film member 52 means, for example, that when liquid is dropped on each of the material forming the water-repellent film 52c and the material forming the closure film member 52, the contact angle of the droplet on the material forming the water-repellent film 52c (the angle formed by the tangent at the edge of the droplet) is larger than the contact angle of the droplet on the material forming the closure film member 52.

The engaging member 53 is connected to the tubular member 51. The engaging member 53 extends in the width direction W along the outer surface 31a of the top plate body 31. The engaging member 53 has a connection hole 54. The connection hole 54 is defined by a hole surface 54a. The engaging member 53 is connected to the outer peripheral surface 51a at the hole surface 54a.

The support member 55 extends in the width direction W. The support member 55 is connected to the tubular member 51. The support member 55 extends along the inner surface 31b. Accordingly, the support member 55 protrudes from the top plate body 31 toward the electrode assemblies 80. More specifically, the support member 55 has a first main surface 55a and a second main surface 55b. The first main surface 55a and the second main surface 55b are spaced apart in the up-down direction H. The first main surface 55a faces the top plate body 31 in the up-down direction H. The second main surface 55b faces the electrode assemblies 80 in the up-down direction H. The second main surface 55b may be in contact with the electrode assemblies 80, or may be disposed spaced apart in the up-down direction H.

The support member 55 extends from the first side wall 23a to the second side wall 23b. The expression that the support member 55 extends from the first side wall 23a to the second side wall 23b includes a case where the support member 55 is in contact with the first side wall 23a and the second side wall 23b, and a case where the support member 55 is close to the first side wall 23a and the second side wall 23b, with, for example, an insulating bracket 71 interposed therebetween.

The support member 55 has a clearance hole 56. The clearance hole 56 is a hole extending through the support member 55 in the up-down direction H. When the support member 55, the electrode assemblies 80, and the electrode terminal 40 are viewed in plan in the up-down direction H, the clearance hole 56 of the support member 55 is formed so as not to overlap with the first connection member 42A, the second connection member 42B, the first tabs 91A, 92A, and the second tabs 91B, 92B.

The support member 55 supports the electrode assemblies 80. The expression that the support member 55 supports the electrode assemblies 80 includes not only a case where the support member 55 is in contact with the electrode assemblies 80, but also a case where the second main surface 55b of the support member 55 is spaced apart from the electrode assemblies 80. More specifically, examples in which the support member 55 supports the electrode assemblies 80 include a case where the support member 55 is spaced apart from the electrode assemblies 80 when the vehicle 1 is stationary, but the electrode assemblies 80 come into contact with the support member 55 due to vibration of the electrode assemblies 80 during driving of the vehicle 1. Alternatively, such examples include a case where the support member 55 comes into contact with the electrode assemblies 80 due to expansion of the electrode assemblies 80 during use of the energy storage cell 100.

In the energy storage device 3 of the present embodiment, the tubular member 51 connects the engaging member 53 and the support member 55. Accordingly, the engaging member 53 and the support member 55 sandwich the top plate body 31. This configuration reduces the likelihood of the vent valve 50 coming off the top plate body 31 under out-of-plane loads on the top plate 30, such as those caused by a pressure difference between the inside and outside of the housing case 20.

In the energy storage device 3 of the present embodiment, the support member 55 supports the electrode assemblies 80. Accordingly, the support member 55 can suppress, for example, damage to the first tab 91A of the electrode assembly 80 or to the current collector sheet of the electrode assembly 80 due to vibration of the electrode assembly 80 housed in the housing case 20 during driving of the vehicle 1. Alternatively, the support member 55 can suppress damage to the first tab 91A due to the electrode assembly 80 expanding during charging or discharging of the energy storage cell 100 and pressing the first tab 91A against the top plate body 31.

In the energy storage device 3 of the present embodiment, the vent valve 50 and the electrode terminal 40 are provided in the top plate body 31. This configuration can suppress an increase in the size of the energy storage cell 100.

### First Modification

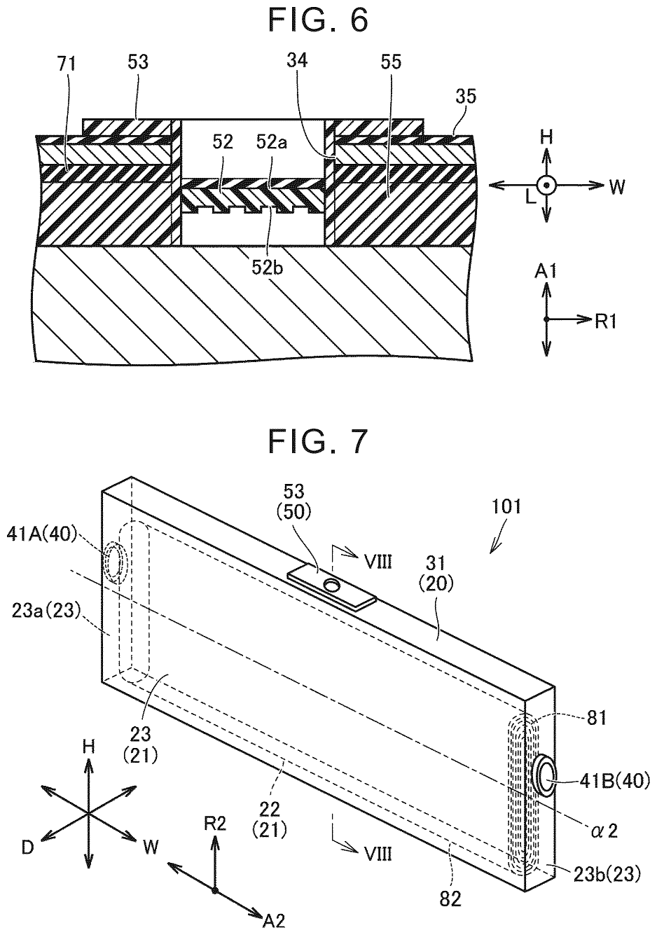

In the embodiment of the present disclosure, the gas permeability of the material forming the vent valve 50 with respect to carbon dioxide may be 1 (g·m²·24 h·1. 1 atm) or more. Specifically, the material forming the vent valve 50 may be a resin material such as polyethylene or polypropylene. As shown in FIG. 6, irregularities may be provided on the inner surface 52b of the closure film member 52. Such a configuration can increase the surface area of the inner surface 52b. Carbon dioxide generated inside the housing case 20 can be released by permeation, thereby suppressing expansion of the housing case 20.

### Second Modification

The first electrode assembly 81 is a wound electrode assembly formed by winding electrode sheets around the winding axis α1. The embodiment of the present disclosure illustrates an example in which the first axial direction Al of the winding axis α1 is a direction passing through the bottom plate 22 and the top plate body 31, that is, the same direction as the up-down direction H. However, the present disclosure is not limited to this. For example, the axial direction of the winding axis of the first electrode assembly 81 may be a direction passing through the first side wall 23a and the second side wall 23b, i.e., may be the same direction as the width direction W.

FIG. 7 is a perspective view of a modification of the energy storage cell according to the embodiment of the present disclosure. An energy storage cell 101, which is a modification of the energy storage cell 100, has substantially the same configuration as the energy storage cell 100 except for the following.

The energy storage cell 101 includes the housing case 20 that houses the first electrode assembly 81. The housing case 20 includes the case body 21 and the top plate body 31. The case body 21 includes the bottom plate 22 and the peripheral wall 23 that extends upward in the up-down direction H from the bottom plate 22. The top plate body 31 and the bottom plate 22 are spaced apart in the up-down direction H. That is, the peripheral wall 23 connects the top plate body 31 and the bottom plate 22. A vent valve 50 is provided in the top plate body 31. The peripheral wall 23 includes the first side wall 23a and the second side wall 23b. The first side wall 23a and the second side wall 23b are spaced apart in the width direction W. The electrode terminal 40 is provided in each of the first side wall 23a and the second side wall 23b.

In the energy storage cell 101, a second axial direction A2 of the winding axis a2 of the first electrode assembly 81 is a direction passing through the first side wall 23a and the second side wall 23b, that is, the same direction as the width direction W. The vent valve 50 and the first electrode assembly 81 are arranged side by side in a second radial direction R2 that intersects with the second axial direction A2 and is centered on the winding axis a2.

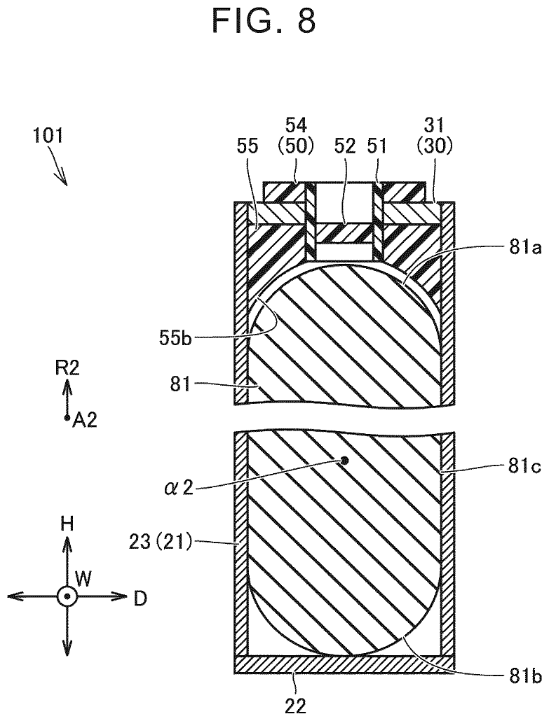

FIG. 8 is a cross-sectional view of the energy storage cell shown in FIG. 7, taken along line VIII-VIII and viewed in the direction of the arrows. The first electrode assembly 81 includes a first arcuate portion 81a, a second arcuate portion 81b, and a flat portion 81c. The flat portion 81c connects the first arcuate portion 81a and the second arcuate portion 81b. The first arcuate portion 81a and the second arcuate portion 81b are spaced apart in the up-down direction H. The first arcuate portion 81a is located closer to the vent valve 50 in the up-down direction H than the second arcuate portion 81b. The vent valve 50 includes the support member 55 formed to extend along the first arcuate portion 81a. That is, the second main surface 55b of the support member 55 supports the first electrode assembly 81. The support member 55 may be in contact with the first arcuate portion 81a of the first electrode assembly 81, or may be spaced apart from the first arcuate portion 81a.

In this way, the support member 55 formed to extend along the first arcuate portion 81a can provide a larger contact area with the first electrode assembly 81 compared with a support member formed not to extend along the first arcuate portion 81a. With such support by the support member 55, application of localized loads to the first electrode assembly 81 can be suppressed. As a result, damage to the first electrode assembly 81 can be suppressed.

Although the embodiments of the present disclosure have been described above, the embodiments disclosed herein should be considered to be illustrative in all respects and not restrictive. The technical scope of the present disclosure is defined by the claims, and is intended to include all modifications within the meaning and scope equivalent to those of the claims.

What is claimed is:

1. An energy storage device comprising:
an electrode assembly; and
a housing case housing the electrode assembly, wherein:
the housing case includes a first main wall having a valve hole, and a vent valve closing the valve hole;
the vent valve includes a tubular member, a closure film member provided inside the tubular member, and an engaging member and a support member that are connected to the tubular member;
the tubular member extends along a hole surface that defines the valve hole;
the engaging member is provided on an outer surface of the first main wall; and
the support member is provided on an inner surface of the first main wall and supports the electrode assembly.

2. The energy storage device according to claim 1, wherein a water-repellent film having higher water repellency than the closure film member is provided on an outer surface of the closure film member .

3. The energy storage device according to claim 1, wherein irregularities are provided on an inner surface of the closure film member.

4. The energy storage device according to claim 1, wherein:
the housing case includes a second main wall spaced apart from the first main wall in a first direction, and a peripheral wall connecting the first main wall and the second main wall; and
the peripheral wall includes a first side wall and a second side wall that are spaced apart in a second direction intersecting with the first direction; and
the support member extends from the first side wall to the second side wall.

5. The energy storage device according to claim 1, wherein the support member is in contact with the electrode assembly.
